(19) United States
(12) Patent Application Publication
(10) Pub. No.: US 2010/0205222 A1
(43) Pub. Date: Aug. 12, 2010

(54) MUSIC PROFILING

(76) Inventors: Tom Gajdos, Dalby (SE); Emil Hansson, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/368,554

(22) Filed: Feb. 10, 2009

(51) Int. Cl. G06F 17/30

(52) U.S. Cl. 707/803; 707/E17.014; 707/E17.009

(57) ABSTRACT

A method of creating a profile of a library having a plurality of audio files and a method of recommending audio-based content to a user based on a library profile. The audio-based content may be, for example, music or songs. A method of creating a profile of a library having a plurality of audio files comprises obtaining a fingerprint of each audio file in the library, the fingerprint of an audio file being a representation of sound data associated with the audio file; and determining a fingerprint of the library, the library fingerprint being a composite of the fingerprints of each audio file in the library. A method of recommending audio-based content stored in an audio-database on a system to a user comprises obtaining a fingerprint of a user library having a plurality of audio files, the library fingerprint being a composite of a fingerprint of each audio file in the library; comparing the user's library fingerprint to the fingerprint of the audio files in the audio file database; and selecting at least one audio file from the audio file database for recommending to a user, the selected at least one audio file having a fingerprint similar to the user's fingerprint within a pre-determined tolerance.

### TECHNICAL FIELD OF THE INVENTION

The present invention relates to a method of creating a profile of a library, e.g., a user library, containing audio files and using such profiles for recommending audio-based content to a user.

### DESCRIPTION OF THE RELATED ART

Music service systems are used in connection with downloading audio-based content, e.g., music, movies, “podcasts,” and the like, to play on electronic devices including personal computers, portable electronic music players, e.g., MP3 players, iPods, and the like. Music service systems typically allow users to preview and purchase audio-based content. Such music service systems may also make recommendations to users of other audio-based content that the user may be interested in purchasing. Such recommendations are typically made on a particular audio-based file, e.g., a song, a movie, or a podcast that the user has previously purchased or that they are currently observing or “testing” on the music service system. For example, if a user has purchased “Where the Streets Have No Name” by U2, the system may recommend other songs that were purchased by other users who also purchased “Where the Streets Have No Name.” A music service system may also make a recommendation based on metadata associated with a song. For example, an audio file for a song may include metadata indicating a particular genre. The music service system may recommend songs to a user that are from the same genre as songs purchased by a user.

### SUMMARY

According to one aspect of the invention, a method of creating a profile of a library containing audio content is provided. In one aspect, the method comprises obtaining a fingerprint of each audio file in the library, the fingerprint of an audio file being a representation of sound data associated with the audio file, non-sound data associated with the audio file, or a combination thereof; and determining a fingerprint of the library, the library fingerprint being a composite of the fingerprints of a plurality of audio files in the library.

According to another aspect, the audio files are song files.

According to another aspect, the fingerprint of an audio file comprises non-sound metadata associated with the audio file.

According to another aspect, the library fingerprint represents a music profile of the library. The music profile may be a user's music profile.

According to another aspect, the fingerprint of an audio file is based on a twelve tone analysis of the sound data.

According to another aspect, determining the library fingerprint comprises averaging the fingerprints of the audio files in the library.

According to another aspect, determining the library fingerprint comprises determining a weighted composite of the audio file fingerprints in the library.

According to another aspect, determining the weighted composite of the audio file fingerprints comprises evaluating sound data and non-sound metadata associated with (i) each audio file, (ii) the library, or (i) and (ii).

According to another aspect, the non-sound metadata is a genre, an activity, a location, a time period, a placeholder of the audio file in the library, an average play position of the audio file, a play count value of the audio file, an average play time of the audio file, or a combination of two or more thereof.

According to another aspect, the audio-based library comprises all the audio files stored on the electronic device, and the profile represents an overall audio-based profile.

According to another aspect, the audio-based library is a subset of the overall library containing fewer than all the audio files stored on the electronic device.

According to another aspect, a method of recommending audio-based content contained in an audio file database stored on a system is provided. The method comprises obtaining a fingerprint of a user library having a plurality of audio files, the library fingerprint being a composite of a fingerprint of each audio file in the library; comparing the user's library fingerprint to the fingerprint of the audio files in the audio file database; and selecting at least one audio file from the audio file database for recommending to a user, the selected at least one audio file having a fingerprint similar to the user's fingerprint within a pre-determined tolerance.

According to another aspect, the audio files are song files.

According to another aspect, obtaining a fingerprint of the library comprises obtaining a library fingerprint from a user.

According to another aspect, obtaining a fingerprint of the library comprises the system obtaining a fingerprint by (i) obtaining a list of songs in a user library, (ii) determining a fingerprint of each song in the library, and (iii) determining a fingerprint of the library.

According to another aspect, (i) the comparing operation comprises comparing the user's library fingerprint to a fingerprint of at least one database library in the database, the at least one database library comprising a plurality of songs from the audio file database, (ii) the selecting operation comprises selecting at least one database library having a similar fingerprint to the user's library fingerprint, and (iii) the recommending operation comprises recommending at least one song from the database library to a user.

According to another aspect of the invention, an electronic device comprises a memory; a plurality of audio files stored in the memory; a library containing a plurality of the audio files; and a processor that executes logic to: obtain a fingerprint of each audio file in the library, the fingerprint being a representation of sound data associated with a respective audio file, non-sound data associated with a respective audio file, or a combination thereof; and determine a fingerprint of the library, the library fingerprint being a composite of the fingerprints of a plurality of audio files in the library.

According to another aspect, the processor further executes logic to transmit the library fingerprint to a system having an audio file database for recommending audio-based content.

According to another aspect, the processor further executes logic to receive a recommendation of audio-based content from the system having an audio file database.

According to another aspect, the device is a portable communication device.

According to another aspect, the device is a mobile telephone.

According to another aspect of the invention, an audio service system comprises a storage device; at least one audio file database; and an audio profile server, the audio profile server containing an application for comparing fingerprints of audio files stored in the at least one audio file database to a fingerprint of a library containing a plurality of audio files, the library fingerprint representing a composite of the audio files in the library.

Another aspect of the invention relates to a program stored on a machine readable medium, the program being suitable for use in an electronic device, wherein the program is loaded in memory in the electronic device and executed, causing the electronic device to obtain a fingerprint of each audio file in a library comprising a plurality of audio files, the fingerprint of an audio file being a representation of sound data associated with the audio file; and determine a fingerprint of the library, the library fingerprint being a composite of the fingerprints of each audio file in the library.

Another aspect of the invention relates to a program stored on a machine readable medium, wherein the program is loaded in memory in a system and executed causes the system to obtain a fingerprint of a user library having a plurality of audio files, the library fingerprint being a composite of a fingerprint of each audio file in the library; compare the user's library fingerprint to the fingerprint of at least one audio file stored in an audio file database in the system; and select at least one audio file from the audio file database for recommending to a user, the selected at least one audio file having a fingerprint similar to the user's fingerprint within a pre-determined tolerance.

These and other features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described or illustrated with respect to one embodiment may be used in the same way or in a similar way in one or more other embodiments and/or in combination with or instead of the features of the other embodiments.

It should be emphasized that the term “comprises/comprising” when used in the specification is taken to specify the presence of stated features, integers, steps, or components, but does not preclude the presence or addition of one or more features, integers, steps, components, or groups thereof.

### BRIEF DESCRIPTION OF THE DRAWINGS

Aspects of the invention may be better understood with reference to the following drawings. The components of the drawings are not necessarily to scale, emphasis instead being placed upon clearly illustrating the principles of the present invention. Likewise, elements and features in one drawing may be combined with elements and features depicted in other drawings. Moreover, like reference numerals designate corresponding parts throughout the several views.

While the diagrams or flow charts may show a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores, or messages may be added to the logical flow for purposes of enhanced utility, accounting, performance, measurement, troubleshooting, and the like. It is understood that all such variations are within the scope of the present invention.

FIG. 1 is a schematic illustration of a system and components suitable for performing aspects of the disclosed methods;

FIG. 2 is a schematic illustration of components of an exemplary electronic device in accordance with aspects of the present invention;

FIG. 3 is a schematic illustration of a library structure of a user's audio-based content exemplified as a library structure of a user's music library;

FIG. 4 is a schematic flow chart illustrating exemplary logic in creating a fingerprint of a user's audio-based library;

FIG. 5 is a graph depicting a fingerprint of several songs contained in a user's music library; and

FIG. 6 is a schematic flow chart illustrating exemplary logic in recommending audio-based content to a user based on a user's library fingerprint.

### DETAILED DESCRIPTION OF EMBODIMENTS

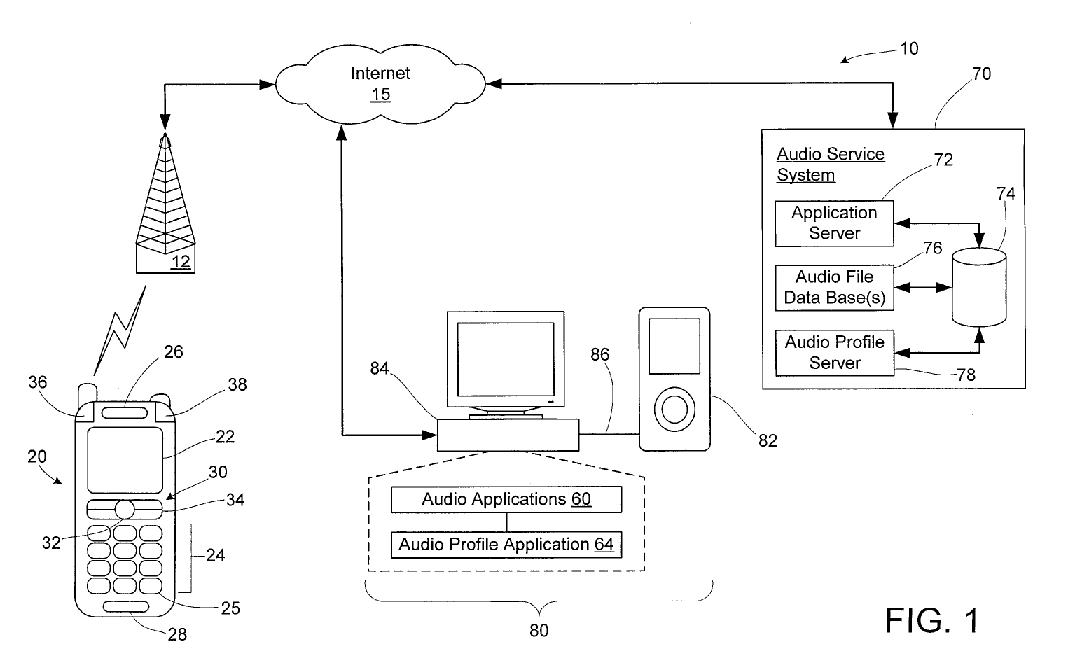

Referring to FIG. 1, a system 10 is shown comprising components suitable for performing or carrying out various aspects for obtaining at least one audio-based profile of a user and/or for recommending audio-based content to a user based on the at least one user audio-based profile. An “audio-based profile” may also be referred to herein as an “audio-based fingerprint,” a “library profile,” or a “library fingerprint.” In some aspects, the term “audio-based content” may be directed to a specific class of audio-based content, e.g., music, movies, television shows, podcasts, and the like.

The terms “electronic equipment” and “electronic device,” which are used interchangeably, include portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus or the like. The term “portable communication device” includes any portable electronic equipment including, for example, mobile radio terminals, mobile telephones, mobile devices, mobile terminals, communicators, pagers, electronic organizers, personal digital assistants, smartphones and the like. The term “portable communication device” also may include portable digital music players and/or video display devices, e.g., iPod® devices, MP3 players, DVD players, etc.

In the present application, aspects of the invention are described primarily in the context of a mobile telephone. However, it will be appreciated that the methods or aspects of the methods are not limited to being performed with a mobile telephone, but can employ any type of electronic equipment including, for example, a computer (e.g., computer 84 in FIG. 1).

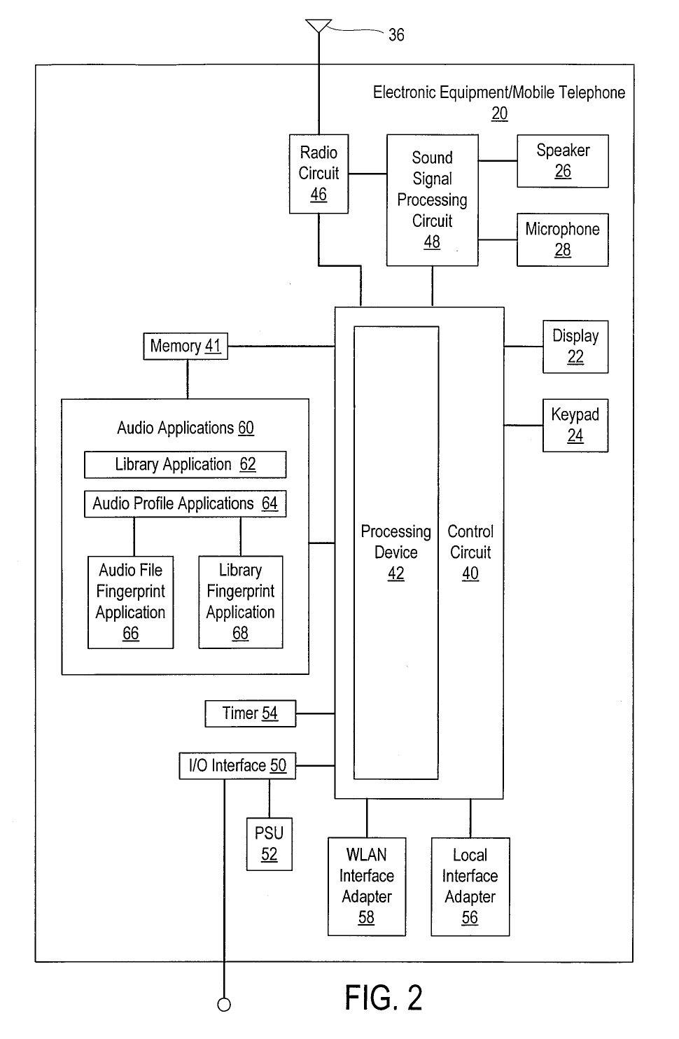

As shown in FIG. 1, system 10 may include an electronic device 20 configured for storing and playing audio-based content and a system 70 for providing audio-based content to a user. The electronic device 20, which is illustrated as a portable network device such as a mobile telephone, includes an audio applications 60 (see also FIG. 2) configured to allow for the playback of audio-based content such as, for example, music, movies, television shows, podcasts, and the like. Audio-based content may be stored on a device or electronic equipment in the form of audio files. Audio files may include sound data and metadata. In some aspects, an audio file may be part of another file (e.g., an audio-visual file) having a video file or component. For purposes of convenience, the system 10 and methods utilizing such systems may be described with reference to music as the audio-based content. As such, various components may be described with respect to songs, music, song files, music files, and the like. For example, the system 70 may also be referred to as “audio service system” or a “music service system.” It will be appreciated, however, that this is for the purpose of convenience, and does not limit the term “audio-based content” or aspects or components modified by the term “audio-based content” to music.

Audio-based content may be in the form of audio files, such as song files, and may be loaded onto and stored on the electronic device 20 by the user from the user's personal collection of audio-based content (e.g., compact discs) by, for example, uploading the audio-based content from a source such as a compact disc onto a computer and then uploading the audio-based content from the computer to the electronic device 20.

Audio-based content (such as music) may also be downloaded onto the electronic device 20 by downloading audio-based content from a provider such as the system 70. The electronic device 20 is illustrated as a portable network device and may connect to the system 70 via the Internet 15, which may be accessed by the electronic device 20 through a suitable communication standard such as, for example, a Wireless Local Area Network (WLAN) 12.

The audio-based content service system 70 includes an application server 72 and a storage device 74, such as a memory for storing data accessible or otherwise usable by the application servers 72. The audio-based content service system 70 includes a database 76 of audio-based content. The audio-based content in the database 76 may be in the form of audio files. In one aspect, the database 76 includes a plurality of song files. The files in the database may be arranged in database libraries based on various characteristics or data associated with the audio files. For example, in the case of music or songs, the database may include libraries based on a particular genre, a particular artist, or the like. Upon connecting to the music service system 70, the user, via the electronic device 20, may access the database 76 to search for and purchase audio-based content (e.g., songs).

Referring to FIG. 1, an electronic device 20 suitable for use with the disclosed methods and applications is shown. The electronic device 20 in the exemplary embodiment is shown as a portable network communication device, e.g., a mobile telephone, and will be referred to as the mobile telephone 20. The mobile telephone 20 is shown as having a “brick” or “block” design type housing, but it will be appreciated that other type housings, such as clamshell housing or a slide-type housing, may be utilized without departing from the scope of the invention.

As illustrated in FIG. 1, the mobile telephone 20 may include a user interface that enables the user to easily and efficiently perform one or more communication tasks (e.g., enter in text, display text or images, send an E-mail, display an E-mail, receive an E-mail, identify a contact, select a contact, make a telephone call, receive a telephone call, etc.). The mobile phone 20 includes a case (housing), display 22, a keypad 24, speaker 26, microphone 28, and a number of keys 30. The display 22 may be any suitable display, including, e.g., a liquid crystal display, a light emitting diode display, or other display. The keypad area 24 comprising a plurality of keys 25 (sometimes referred to as dialing keys, input keys, etc.) The keys in keypad area 24 may be operated, e.g., manually or otherwise to provide inputs to circuitry of the mobile phone 20, for example, to dial a telephone number, to enter textual input such as to create a text message, to create an email, or to enter other text, e.g., a code, pin number, security ID, to perform some function with the device, or to carry out some other function.

The keys 30 may include a number of keys having different respective functions. For example, the key 32 may be a navigation key, selection key, or some other type of key, and the keys 34 may be, for example, soft keys or soft switches. As an example, the navigation key 32 may be used to scroll through lists shown on the display 22, to select one or more items shown in a list on the display 22, etc. The soft switches 34 may be manually operated to carry out respective functions, such as those shown or listed on the display 22 in proximity to the respective soft switch. The speaker 26, microphone 28, display 22, navigation key 32 and soft keys 34 may be used and function in the usual ways in which a mobile phone typically is used, e.g. to initiate, to receive and/or to answer telephone calls, to send and to receive text messages, to connect with and carry out various functions via a network, such as the Internet or some other network, to beam information between mobile phones, etc. These are only examples of suitable uses or functions of the various components, and it will be appreciated that there may be other uses, too.

The mobile telephone 20 includes a display 22. The display 22 displays information to a user such as operating state, time, telephone numbers, contact information, various navigational menus, status of one or more functions, etc., which enable the user to utilize the various features of the mobile telephone 20. The display 22 may also be used to visually display content accessible by the mobile telephone 20. The displayed content may include E-mail messages, geographical information, journal information, audio and/or video presentations stored locally in memory 41 (FIG. 2) of the mobile telephone 20 and/or stored remotely from the mobile telephone 20 (e.g., on a remote storage device, a mail server, remote personal computer, etc.), information related to audio content being played through the device (e.g., song title, artist name, album title, etc.), and the like. Such presentations may be derived, for example, from multimedia files received through E-mail messages, including audio and/or video files, from stored audio-based files or from a received mobile radio and/or television signal, etc. The displayed content may also be text entered into the device by the user. The audio component may be broadcast to the user with a speaker 26 of the mobile telephone 20. Alternatively, the audio component may be broadcast to the user though a headset speaker (not shown).

The device 20 optionally includes the capability of a touchpad or touch screen. The touchpad may form all or part of the display 22, and may be coupled to the control circuit 40 for operation as is conventional.

Various keys other than those keys illustrated in FIG. 1 may be associated with the mobile telephone 20 may include a volume key, audio mute key, an on/off power key, a web browser launch key, an E-mail application launch key, a camera key, etc. Keys or key-like functionality may also be embodied as a touch screen associated with the display 22.

The mobile telephone 20 includes conventional call circuitry that enables the mobile telephone 20 to establish a call, transmit and/or receive E-mail messages, and/or exchange signals with a called/calling device, typically another mobile telephone or landline telephone. However, the called/calling device need not be another telephone, but may be some other device such as an Internet web server, E-mail server, content providing server, etc.

Referring to FIG. 2, a functional block diagram of the mobile telephone 20 is illustrated. The mobile telephone 20 includes a primary control circuit 40 that is configured to carry out overall control of the functions and operations of the mobile telephone 20. The control circuit 40 may include a processing device 42, such as a CPU, microcontroller or microprocessor. The processing device 42 executes code stored in a memory (not shown) within the control circuit 40 and/or in a separate memory, such as memory 41, in order to carry out operation of the mobile telephone 20.

The memory 41 may be, for example, a buffer, a flash memory, a hard drive, a removable media, a volatile memory and/or a non-volatile memory.

Continuing to refer to FIGS. 1 and 2, the mobile telephone 20 includes an antenna 36 coupled to a radio circuit 46. The radio circuit 46 includes a radio frequency transmitter and receiver for transmitting and receiving signals via the antenna 36 as is conventional. The mobile telephone 20 generally utilizes the radio circuit 46 and antenna 36 for voice and/or E-mail communications over a cellular telephone network. The mobile telephone 20 further includes a sound signal processing circuit 48 for processing the audio signal transmitted by/received from the radio circuit 46. Coupled to the sound processing circuit 48 are the speaker 26 and a microphone 28 that enable a user to listen and speak via the mobile telephone 20 as is conventional. The radio circuit 46 and sound processing circuit 48 are each coupled to the control circuit 40 so as to carry out overall operation.

The mobile telephone 20 also includes the aforementioned display 22 and keypad 24 coupled to the control circuit 40. The device 20 and display 22 optionally includes the capability of a touchpad or touch screen, which may be all of part of the display 22. The mobile telephone 20 further includes an I/O interface 50. The I/O interface 50 may be in the form of typical mobile telephone I/O interfaces, such as a multi-element connector at the base of the mobile telephone 20. As is typical, the I/O interface 50 may be used to couple the mobile telephone 20 to a battery charger to charge a power supply unit (PSU) 52 within the mobile telephone 20. In addition, or in the alternative, the I/O interface 50 may serve to connect the mobile telephone 20 to a wired personal hands-free adaptor, to a personal computer or other device via a data cable, etc. The mobile telephone 20 may also include a timer 54 for carrying out timing functions. Such functions may include timing the durations of calls and/or events, tracking elapsed times of calls and/or events, generating timestamp information, e.g., date and time stamps, etc.

The mobile telephone 20 may include various built-in accessories. For example, the device 20 may include a camera for taking digital pictures. Image files corresponding to the pictures may be stored in the memory 41. In one embodiment, the mobile telephone 20 also may include a position data receiver, such as a global positioning satellite (GPS) receiver 34, Galileo satellite system receiver, or the like. The mobile telephone 20 may also include an environment sensor to measure conditions (e.g., temperature, barometric pressure, humidity, etc.) in which the mobile telephone is exposed.

The mobile telephone 20 may include a local wireless interface adapter 56, such as a Bluetooth adaptor to establish wireless communication with other locally positioned devices, such as the a wireless headset, another mobile telephone, a computer, etc. In addition, the mobile telephone 20 may also include a wireless local area network interface adapter 58 to establish wireless communication with other locally positioned devices, such as a wireless local area network, wireless access point, and the like. Preferably, the WLAN adapter 58 is compatible with one or more IEEE 802.11 protocols (e.g., 802.11(a), 802.11(b) and/or 802.11(g), etc.) and allows the mobile telephone 20 to acquire a unique address (e.g., IP address) on the WLAN and communicate with one or more devices on the WLAN, assuming the user has the appropriate privileges and/or has been properly authenticated.

As shown in FIG. 2, the processing device 42 is coupled to memory 41. Memory 41 stores a variety of data that is used by the processor 42 to control various applications and functions of the device 20. It will be appreciated that data can be stored in other additional memory banks (not illustrated) and that the memory banks can be of any suitable types, such as read-only memory, read-write memory, etc. The memory 41 may store audio-based content, e.g., audio files including song files, for playback by a user of the device.

The electronic device 20 includes audio applications 60. Audio applications 60 contain applications suitable for the storage and playback of audio-based files using the electronic device 20. The audio applications 60 may be coupled to the memory 41 for access to the audio-based files stored in the memory 41. The audio applications 60 may include library application 62 stored on the electronic device. Library application 62 is configured to provide and/or allow a user to provide one or more libraries containing audio files. As used herein, a library refers to a collection of a plurality of audio-based files. The library application 62 is configured to provide an overall, or primary, library containing all the audio files stored on a device. The library application 62 is also configured to provide, or allow, a user to create subsets, which contain two or more audio files. A library subset may contain any number of audio files, but contains fewer than all the audio files stored on the device. The term “library” encompasses a primary library, which contains all the audio-based files stored on the electronic device, and library subsets, which contain subsets of the audio files stored on the electronic device. A library subset may also be referred to as simply a “library,” which may or may not be modified by another term to define or label the contents of the library, or a library subset may also be referred to as a playlist. The primary library may refer to the entire collection of a particular audio-based file. For example, a primary library may be a primary music library containing all of the user's stored music or song files. The library subsets may be user created or created by the library application. The library application may create library subsets based on metadata associated with an audio file. For example, a song file may include metadata such as the genre, artist name, album name, and the like. The library application 62 may also be configured to determine various features or data associated with a library such as, for example, a library name, the date created, who created the library, the order of audio files, the date the library was edited, the order (and/or average order) in which audio files in the library are played, the number and/or average number of times an audio file is played in the library, etc.

As described above, a library may refer to any collection of audio files storable or stored on a device. This may include, for example, a collection of files obtained from audio streams or a radio station.

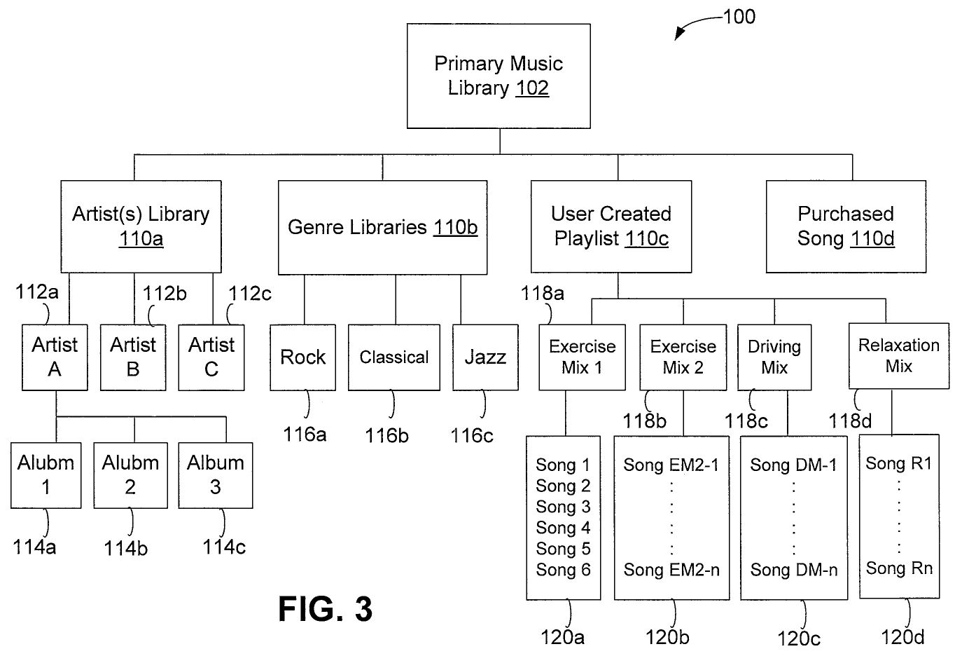

FIG. 3 illustrates an example of a music library structure 100. The music library 100 includes a primary music library 102 that includes all the song files stored on the electronic device. The library 100 also includes a plurality of library subsets 110a-110d, each of which contains songs from the primary library 102. The library structure 100 in FIG. 3, is shown as having an artist library 110a, a genre library 110b, user created libraries or playlists 110c, and a library 110d of songs purchased by the user. The artist library 110a includes all the songs in the primary library 102 but is broken down into additional subsets, e.g., 112a-112c. Library subsets 112a-112c each contain the songs of a respective artist stored on the device. For example, library subset 112a may contain Artist A, subset 112b may contain Artist B, and subset 112c contains Artist C. The respective artist libraries may include further library subsets that contain the songs of a respective album by a particular artist. For example, library subset 112a of Artist A is shown as having library subsets 114a, 114b, and 114c, which contain the songs from Albums 1, 2, and 3, respectively, by Artist A.

Library 110b is shown as a genre library. Library 110b includes all the songs in primary music library 102, and includes library subsets containing song files identified as belonging to a particular musical genre. In FIG. 3, for example, library 110b includes library subsets 116a, 116b, and 116c, which contain song files classified as falling under the genres of rock, classical, and jazz, respectively.

Libraries 110a and 110b and their respective library subsets are classified based on various metadata, e.g., artist name, album name, genre, etc., associated with an audio file. The audio-based content application 60 and, in particular, library application 62 contain logic and programming configured to extract and recognize metadata associated with an audio file and create library subsets based on such data. The genre metadata associated with a song may be determined by the source from which the song was obtained. For example, a compact disc may have metadata associated with the songs stored thereon that classifies the songs as being in a particular genre. Alternatively, if a song is purchased from a music service system, the music service system may classify the song as belonging to a particular genre. The user may also edit the data and classify an audio file as belonging to a particular genre. Additionally, it will be appreciated that the artist and genre library subsets are not limited to the number of artists, albums, or genres shown in FIG. 3 and may contain as many artists, albums, and genres as are contained within the primary library.

Library structure 100 is also shown as having library subset 110c which contains created playlists. These created playlists may be created by the user or may be playlists obtained from other sources, e.g., the audio-based content service system 70. For example, the service system 70 may create a variety of playlists, which may also be referred to as “mixes,” or may contain playlists created by other users, and which may be purchased by the user of the electronic device 20. As shown in FIG. 3, library 110c includes library subsets 118a-118d. Library 118a is identified as “Exercise Mix 1” and contains six songs (songs 1-6). Library 118b is identified as “Exercise Mix 2” and contains songs EM2-1 through EM2-n. The songs in libraries 118a and 118b may be songs the user enjoys listening to while exercising. Library 118c is identified as “Driving Mix 1” and contains songs DM-1 through DM-n, which the user enjoys hearing while they are driving. Library 118d is identified as “Relaxation Mix” and contains songs RM-1 through RM-n, which the user enjoys listening to help them relax. The library subsets 118a-118d contain fewer than all the songs contained in the primary library. It will be appreciated that a song that is a part of one created playlist may also be a part of another created playlist.

Library structure 100 also includes library subset 110d, which contains songs that the user purchased such as, from the music service system 70. Upon purchasing a song from a music service system, the song file may include metadata identifying it as being purchased and may be automatically included in library 110d.

The various libraries in a user's audio-based library (e.g., a music library) may be used to obtain a profile of the library. The profile may also be referred to as a fingerprint and may be considered a representation of the particular taste or preferences of the user (as it pertains to a particular library). In the context of a user's overall music library, for example, the library fingerprint may be considered a representation of the user's general musical tastes.

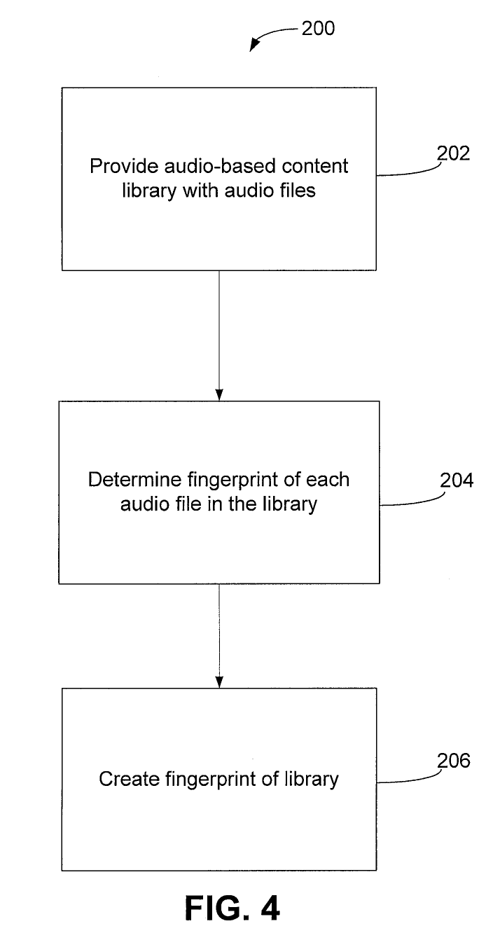

FIG. 4 is a schematic illustration of a method 200 of determining a profile or fingerprint of an audio-based library, such as a music library. The method 200 includes providing a library comprising a plurality of audio files (e.g., song files) at functional box 202. At functional box 204, the method includes obtaining a fingerprint or profile of each audio file in the library. At functional box 206, a fingerprint of the library is determined using the fingerprints of each audio file in the library.

The fingerprint of an audio file may be considered a representation of the audio file and may be based on various audio data associated with the audio file. The audio data from which the fingerprint may be determined may include sound data and/or non-sound metadata associated with an audio file. The audio application 60 includes an audio file fingerprint application 66 (FIG. 2) configured for analyzing and extracting the desired features of the audio data (sound and/or non-sound data) and establishing a profile of the audio file based on such features. The audio data to be extracted for representing an audio file may be selected as desired for a particular purpose or intended use.

The audio file may include sound data associated with, for example, a song, voice recording, or the like. The sound data is typically made up of wave forms and stored in the memory as a wave file. The sound data may include various sound features or characteristics associated with an audio file such as, for example, beat, chord progression, structure, rhythm, mood, and the like. The sound data may be selected and analyzed in any suitable manner as desired to create a fingerprint of an audio file. In one aspect, the wave file may be analyzed and identifiers created to represent aspects of the audio file. In another aspect, the audio file fingerprint application 66 may analyze the sound data of audio file using twelve tone analyses. Twelve tone analyses provides information about features of an audio file, such as a song file, including, but not limited to, key of the music, chord progression, beat, structure, and rhythm. This information can be used to infer the characteristics of the sound data. Features that may be extracted from the sound data include, but are not limited to, tempo (e.g., beats per minute), speed (which is based on tempo and rhythm), dispersion (variance in tempo), major or minor, type of chord, notes per unit of time, rhythm ratio, amplitude, cadence, chord variation, chord complexity, notes, clearness, expanse, density, pitch move, high mid, low mid, and the like. The features to be analyzed and extracted by the song fingerprint application may be selected as desired for a particular purpose or intended use. Analyzing or determining a greater number of sound features may provide a better or more precise representation of the audio file and, subsequently, of a library and/or a user's fingerprint.

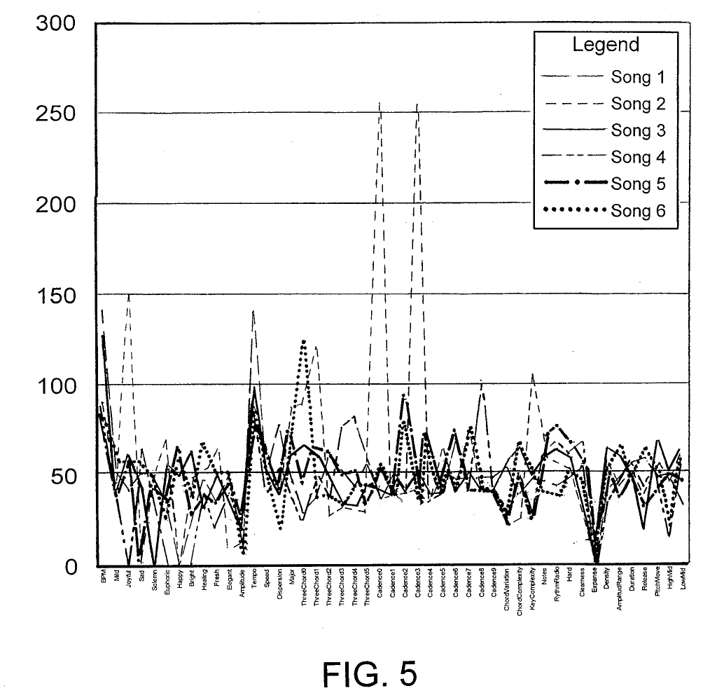

Referring to FIG. 5, exemplary fingerprints of songs (e.g., songs 1-6 from Exercise Mix 118a) are shown. The fingerprints in FIG. 5 are based on numerous factors including beats per minute, mood (e.g., mild, joyful, sad, solemn, euphoric, happy, bright, healing, fresh, elegant), amplitude, tempo, speed, dispersion, major, three chord, cadence, chord variation, chord complexity, key complexity, notes, rhythm radio, hard, clearness, expanse, density, amplitude range, duration, release, pitch move, high mid, and low mid. The audio file fingerprint application will analyze the sound data in the song files, extract the desired features, and provide a score or value (e.g., the numeric values along the Y-axis in FIG. 5) for each feature based on the analysis of the sound data.

The non-sound metadata may include data associated with the audio file that can be used to provide additional information about the audio file. Non-sound data may be pre-defined, user created, and/or playback created data. Non-sound metadata for an audio file may include, for example, artist, album, song title, length, genre, and the like. Such data may be predefined and associated with an audio file obtained from a CD or purchased from a database. Non-sound metadata may also include user created data such as, for example, an activity the user associates the audio file with, a time of year or season the user associates the audio file with, and the like. The user may also be able to define or create genre data for an audio file (in those instances where the genre is pre-defined, but the user does not agree with the classification). The playback created data may be data that is determined from a user's play activity (e.g., number of play counts, average play time, time of day played, etc.) related to the audio file. The audio applications 60, may be configured to allow a user to create and enter non-sound data and/or to determine and extract playback related non-sound data. Non-sound data may be represented in any suitable manner. For example, a code (e.g., a hash code) or identifier may be created to represent various non-sound data.

After the fingerprints for the songs in a library have been obtained, the library fingerprint is then determined. The library fingerprint may be determined, for example, by a library fingerprint application 68 (FIG. 2) associated with the audio-based content applications 60. The library fingerprint application 68 is configured to determine a composite fingerprint of a library based on the fingerprints of the audio files in the library. In one aspect, the library fingerprint may be provided by an average of the scores for the respective sound and/or non-sound data features analyzed for the audio files.

The library fingerprint may also be determined by considering non-sound data features. These non-sound data features, typically present in an audio file or a library file as metadata, may be pre-defined data, programmed by a user, or determined by the library application 62. Non-sound data that may be evaluated for determining a library fingerprint includes, but is not limited to, the order or position of the audio files in the library (or playlist), the average order or position of the audio file (e.g., if the user plays songs from the library in a random order), the average play time of the audio file, the number of times an audio file has been played (a play count value), the number of times an audio file has been played over a selected time frame, the average play position of an audio file over a selected time frame, the genre, whether the audio file was purchased using a particular music system, the average day and/or time of day that an audio file is played, the date(s) the audio file was played an activity associated with the audio file (e.g., exercising, driving, working, reading, relaxing, etc.), a particular location that the audio file is associated with (e.g., at home, at work, on vacation, etc.), and the like. In another aspect, the library fingerprint may be a weighted composite of the fingerprints based on the respective audio file fingerprints and other features associated with the respective audio file fingerprints and/or features associated with the particular library being analyzed. The non-sound data may each be represented in any suitable manner or selected for the purpose of associating the respective non-sound data features with a fingerprint or an audio file and for the purpose of determining a library fingerprint.

The library fingerprint application 68 may be programmed to score or weight the various sound and/or non-sound data features associated with an audio file in the context of a particular library. The library fingerprint application 68 may analyze the audio file fingerprints and library data using statistical analytical methods as desired for a particular purpose or intended use including, for example, various correlation techniques, stochastic analytical methods, and the like.

The above method allows a fingerprint or profile to be determined for a selected library. In one aspect, the method provides a way to determine an overall fingerprint and/or subset(s) of fingerprints that reflect the user's overall music profile or a music profile for a subset of songs based on the sound data associated with the songs in the library and/or library subsets. Further, the method allows for the fingerprint(s) and/or profile(s) to be dynamic in that they will change as new audio files are added to the user's library or library subsets are changed and the library fingerprints re-determined.

In another aspect, by considering both sound data and non-sound data, the method allows unique profiles or fingerprints to be determined that reflect or are indicative of both a user's musical tastes, but also their listening habits. For example, based on evaluating features such as play history, date that audio files are played, average order that an audio file is played, etc., the method may be used to determine a number of different music profiles or fingerprints for a user that is indicative of the user's musical interests for a particular time period (e.g., a particular year, a particular span of years, a particular month or day, a particular month of span of days, etc.), a particular activity, a particular location, a particular genre, etc. An overall music profile or fingerprint may be determined from the entire collection of audio files and the complete play history and representation of other non-sound data. Additionally, the library fingerprint application may be used to evaluate the entire library but create, for example, a profile based on the fingerprints of audio files played during certain activities, at a certain time or time period (for example for the years 2000-2008, 2000-2003, 2006-2008, etc., or for a particular month, and the like), etc., by evaluating certain audio files and certain non-sound data associated therewith. The profile may be created based on a user created library or simply from evaluating data associated with the audio files in the entire library. By selecting how the library fingerprint is determined, a unique fingerprint can be created that is representative of the user's tastes with respect to certain audio-based content, such as a user's musical tastes. Changing the manner in which the fingerprint is determined (e.g., by changing the number of parameters evaluated and/or the weight given to certain sound and/or non-sound data) may provide a different library fingerprint (even for a given library). In another aspect, the user's musical fingerprint can also be determined for a particular album, a particular artist (based on two or more albums of a particular artist), various play lists or library subsets created by the user, songs purchased by a user, songs track id'd by a user, etc. By considering sound and non-sound data, a variety of unique fingerprints may be determined for a particular user. Various non-sound data may be dynamic (e.g., number of play counts, when played, length of play, etc.) and thus the method provides a way to reflect a change in a user's musical taste and/or listening habits over time. Further different users may have unique listening habits. Even between users with an identical music library, using the disclosed method may result in unique or different user or library fingerprints based on the different listening habits of the individual users.

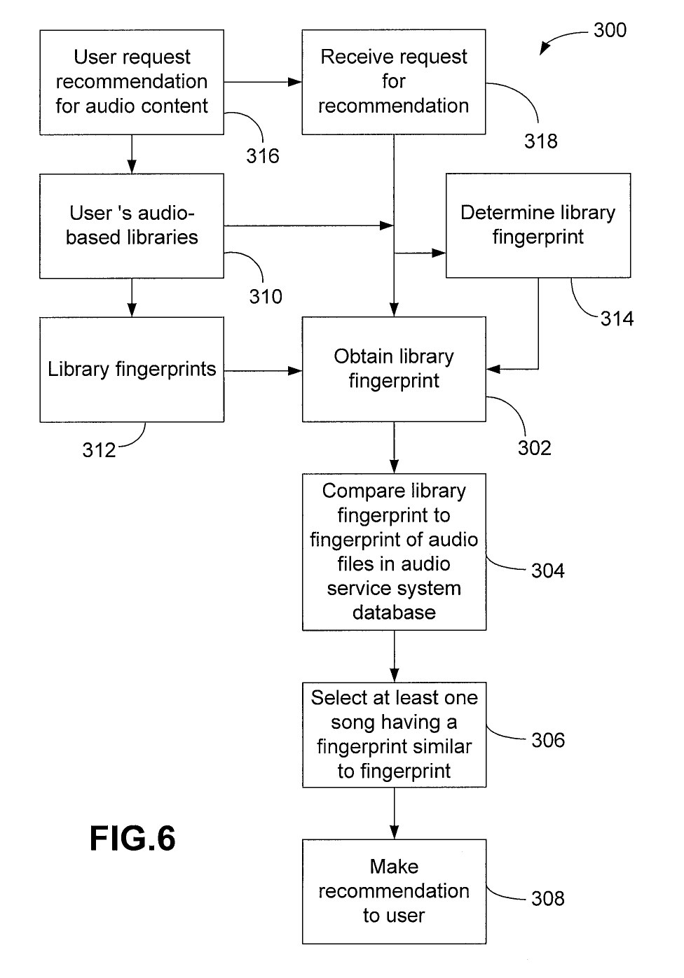

The present invention also provides a method for recommending audio-based content to a user based on a user's audio-based content fingerprint. Referring to FIG. 6, a flow chart or logic progression 300 is shown for recommending audio-based content, e.g., music, to a user based on a user's music fingerprint. In the method 300, as shown in functional box 302, an audio content service system (e.g., system 70 in FIG. 1) obtains a library fingerprint of a particular library in the users stored audio-based libraries. At functional box 304, the music service system compares the library fingerprint to the fingerprints of songs in the music service system's music database. This may be accomplished with appropriate applications such as applications located on the audio profile server 78 of music service system 70. At functional box 306, the audio service system identifies at least one audio-file, e.g., a song, having a fingerprint sufficiently similar to the library fingerprint. The applications on the audio profile server may contain pre-defined definitions to evaluate whether an audio file fingerprint is sufficiently similar to a library fingerprint. The pre-defined definition may be, for example, that the features (e.g., sound and/or non-sound features) of the audio file (to be recommended) are each within a pre-defined limit or percentage of the features of the library fingerprint. Correlation techniques may also be used, for example to compare a library fingerprint to an audio file or another library to determine whether to recommend an audio file (or a library) to a user. At functional box 308, the music system recommends the at least one song identified by the music system to the user as a song that the user may like and may wish to purchase.

It will be appreciated that recommending audio content is not limited to recommending a single audio file to a user based on a comparison to a selected library. The recommended audio content may be a library, such as, for example, an album or a play list created by another user, having a fingerprint similar to the fingerprint of the requesting user's library.

The audio service system 70 may obtain a library fingerprint in any suitable manner. In one aspect, the user's libraries may be accessible to and readable by the audio service system 70 upon the device 20 being connected to the audio service system. As shown in functional box 310 of FIG. 6, the user's overall audio library and/or the library subsets may be detected and read by the audio service system 70. The logic may then flow to functional box 314 where the audio service system 70 determines the fingerprint via a library fingerprint application located, for example, on profile server 78 of the user's different libraries. The audio service system may then compare the fingerprint to fingerprints of audio files in the audio file database and be able to make several different song recommendations based on the different user libraries.

In another aspect, the audio service system 70 may obtain the library fingerprint(s) directly from the user. In this case, the electronic device 20 may contain applications as previously described (e.g., song fingerprint application 66 and/or library fingerprint application 68) to determine a fingerprint for one or more of the user libraries. The fingerprint for the respective libraries may then be uploaded to the audio service system 70. Using programs and applications on the audio profile server 78, the audio service system 70 will compare the obtained fingerprint(s) to the fingerprints of audio files in the audio file database(s) 76, and select one or more audio files to the user. It will be appreciated that the user may select which fingerprint(s) it wishes to upload or, alternatively, all fingerprints may be automatically uploaded or accessible to the audio service system 70 when the device 20 connects to audio server system 70.

Obtaining the fingerprint of one or more user's libraries and making a recommendation to the user may or may not be accompanied by a specific request by the user for such a recommendation. In one aspect, the audio service system 70 may automatically be able to access the user's libraries and/or library fingerprints from the user upon a connection being established between the user's device and the audio service system 70. The audio service system 70 may automatically compare the library fingerprints to the audio files stored in the audio service system's 70 audio database 76 and recommend at least one song to the server. Along these lines, the audio service system 70 could make several recommendations to a user. For example, the music service system could provide the following messages to a user:
“Based on your overall music fingerprint, you may like: Song A, Song B, or Song C;
Based on the fingerprint for the library Driving Mix 1, you may like: Song A, Song D, Song E, or Song F.

The audio service system 70 may also make a recommendation of at least one audio file to a user based on a user initiated request for a recommendation. Referring to FIG. 6, the user may make a request at functional box 316. The system 70 receives the request at functional box 318. The process may flow as described above with respect to FIG. 6. It will be appreciated that the audio service system 70 may obtain the library fingerprints before a user initiated request, substantially simultaneously with the request, or after the user initiates a request for a recommendation.

In addition to recommending audio-based content based on the similarity of a particular audio file's fingerprint to a user's library fingerprint, the service system 70 may recommend one or more audio files from a database library, where the database library has a fingerprint similar to the user's library. The database library may be a library comprising a subset of songs from the overall database. The service system may recommend each song in the database library or may recommend selected songs from the database library. For example, a database library may be an album by a particular artist. Upon evaluating the user's overall music profile, for example, the system 70 may identify several albums, from the same or different artists, having a profile or fingerprint similar to the user's overall fingerprint and may recommend those albums or individual songs from these albums to the user.

As another example, the order in which the songs in a library are played may affect the fingerprint of the library. The library may contain a string of fast songs followed by a slow song and then a fast song. The fingerprint may take this into account, and the audio service system may be able to recommend an album or playing having a similar behavior.

A person having skill in the art of programming will, in view of the description provided herein, be able to ascertain and program an electronic device or provide a system to carry out the functions described herein with respect to either the audio fingerprint application, the library fingerprint application, an application for comparing audio file fingerprints (including database library fingerprints) to library fingerprints, and other application programs. Accordingly, details as to specific programming code have been left out for the sake of brevity. Also, while the various applications are carried out in memory of the respective electronic device 20 (or 84) and system 70, it will be appreciated that such functions could also be carried out via dedicated hardware, firmware, software, or combinations of two or more thereof without departing from the scope of the present invention.

Creating user profiles/fingerprints as described above allows for a user's overall musical taste as well as the user's musical tastes as it relates to particular activities, times, locations, artists, genres, etc., to be continually evaluated to reflect the dynamic aspects of a user's musical tastes and listening habits. The method allows, for example, for a user's musical taste to be evaluated over time and reflect the changing musical tastes. These unique profiles allow for a music service system to recommend music or audio-based content in-line with the user's musical taste(s) and/or listening habits rather than simply being based on a single song. Further, the recommending is tailored to the user rather than what other people who may have purchased similar songs have also purchased or liked.

While the various methods have been particularly described with respect to electronic device 20, the methods are amenable to other devices and systems for storing and playing audio files. Device 20 is illustrated as a portable network device that can itself connect to an audio service system. It will be appreciated that some devices for playing audio files may not be network devices. Such devices typically communicate with another electronic device having network capabilities. For example, referring to FIG. 1, the methods described herein are amenable with a system 80 that includes an audio player 82 for storing and playing audio files. The audio player 82 may be connectable to a computer 84 (via a connection 86, such as through a USB cable) for transfer of audio files from the computer 84 to the audio player 82. The computer may be able to connect to and communicate with the audio service system 70 (via the Internet) to download audio files. The computer 84 may also include audio applications (such as those described with respect to the device 20) for storing and playing audio files. For example, FIG. 1 shows that computer 84 includes audio applications 60 and audio profile application 64. The computer 84 may also include other applications (e.g., library application 62, such as audio file fingerprint application 66 and library fingerprint application 68) for carrying out the described methods.

Although the invention has been shown and described with reference to certain exemplary embodiments, it is understood that equivalents and modifications may occur to others skilled in the art upon reading and understanding the specification. The present invention is intended to include all such equivalents and modifications as they come within the scope of the following claims.

1. A method of creating an audio profile of an audio-based library stored on an electronic device and having a plurality of files, the method comprising:
obtaining a fingerprint of each audio file in the library, the fingerprint of an audio file being a representation of sound data associated with the audio file, non-sound data associated with the audio file or a combination thereof; and
determining a fingerprint of the library, the library fingerprint being a composite of the fingerprints of a plurality of audio files in the library.

2. The method of claim 1, wherein the audio files are song files.

3. The method according to claim 1, wherein the fingerprint of an audio file is based on a twelve tone analysis of the sound data.

4. The method according to claim 1, wherein determining the library fingerprint comprises averaging the fingerprints of the audio files in the library.

5. The method according to claim 1, wherein determining the library fingerprint comprises determining a weighted composite of the audio file fingerprints in the library.

6. The method according to claim 5, wherein determining the weighted composite of the audio file fingerprints comprises evaluating sound data and non-sound metadata associated with (i) each audio file, (ii) the library, or (i) and (ii).

7. The method according to claim 6, wherein the non-sound metadata is a genre, an activity, a location, a time period, a placeholder of the audio file in the library, an average play position of the audio file, a play count value of the audio file, an average play time of the audio file, or a combination of two or more thereof.

8. The method according to claim 1, wherein the audio-based library comprises all the audio files stored on the electronic device, and the profile represents an overall audio-based profile.

9. The method according to claim 1, wherein the audio-based library is a subset of the overall library containing fewer than all the audio files stored on the electronic device.

10. A method of recommending, to a user, audio-based content contained in an audio file database stored on a system, the method comprising:
obtaining a fingerprint of a user audio-based library having a plurality of audio files, the library fingerprint being a composite of a fingerprint of each audio file in the library;
comparing the user's library fingerprint to the fingerprint of the audio files in the audio file database; and
selecting at least one audio file from the audio file database for recommending to a user, the selected at least one audio file having a fingerprint similar to the user's fingerprint within a pre-determined tolerance.

11. The method of claim 10, wherein the audio files are song files.

12. The method of claim 10, wherein obtaining a fingerprint of the library comprises obtaining a library fingerprint from a user.

13. The method of claim 10, wherein obtaining a fingerprint of the library comprises the system obtaining a fingerprint by (i) obtaining a list of songs in a user library, (ii) determining a fingerprint of each song in the library, and (iii) determining a fingerprint of the library.

14. The method according to claim 10, wherein (i) the comparing operation comprises comparing the user's library fingerprint to a fingerprint of at least one database library in the database, the at least one database library comprising a plurality of songs from the audio file database, (ii) the selecting operation comprises selecting at least one database library having a similar fingerprint to the user's library fingerprint, and (iii) the recommending operation comprises recommending at least one song from the database library to a user.

15. The method according to claim 10, wherein selecting at least one audio file from the audio file database for recommending to a user comprises selecting a library comprising two or more audio files from the audio file database.

16. An electronic device comprising:
a memory;
a plurality of audio files stored in the memory;
a library containing a plurality of the audio files; and
a processor that executes logic to:
obtain a fingerprint of each audio file in the library, the fingerprint being a representation of sound data associated with a respective audio file, non-sound data associated with a respective audio file, or a combination thereof; and
determine a fingerprint of the library, the library fingerprint being a composite of the fingerprints of a plurality of audio files in the library.

17. The device of claim 16, wherein the processor further executes logic to transmit the library fingerprint to a system having an audio file database for recommending audio-based content.

18. The device of claim 17, wherein the processor further executes logic to receive a recommendation of audio-based content from the system having an audio file database.

19. The device of claim 16, wherein the device is a portable communication device.

20. The device of claim 16, wherein the device is a mobile telephone.
